(19) United States
(12) Patent Application Publication
(10) Pub. No.: US 2010/0063425 A1
(43) Pub. Date: Mar. 11, 2010

(54) SUPPORT FOR A CPR APPARATUS

(76) Inventors: Benjamin King, Takaka (NZ); Peter Sebelius, Malmo (SE)

Correspondence Address: OSTROLENK FABER GERB & SOFFEN, 1180 AVENUE OF THE AMERICAS, NEW YORK, NY, 100368403, US

(21) Appl. No.: 12/516,437

(22) PCT Filed: Nov. 28, 2007
(86) PCT No.: PCT/SE07/01053

§ 371 Date: Jun. 18, 2009

(30) Foreign Application Priority Data
Nov. 29, 2006 (SE) 0602556-3

(51) Int. Cl. A61H 31/00; F16M 13/00; F16M 11/22

(52) U.S. Cl. 601/41; 248/346.01; 248/176.1

(57) ABSTRACT

A support frame for a CPR apparatus, in particular a gas-driven CPR apparatus, comprises one or more support elements, which can be inflated by a gas, in particular by the driving gas. The support elements have a flexible but substantially not resilient wall. Also disclosed is the combination of a CPR apparatus and the support frame.

### FIELD OF THE INVENTION

The present invention relates to an inflatable support for a cardiopulmonary resuscitation (CPR) apparatus and a CPR apparatus provided with the support as well as methods of using the support and the apparatus.

### BACKGROUND OF THE INVENTION

Cardiac arrest risks to be lethal or at least severely disabilitating if circulation and oxygenation of blood are not restored within a short time, that is, within a few minutes. While circulation and oxygenation can be restored by heart massage provided manually or, preferably, by means of a CPR apparatus, the restart of a normal heart beat requires defibrillation by electrical chock. Cardiac arrest may hit anybody anywhere. CPR other than by hand required access to a CPR apparatus within that time frame or at least within a time period during which circulation and oxygenation are provisionally maintained by manual heart massage. CPR apparatus used in the field by medical personnel, such as an ambulance team, or even by persons who received a basic medical training only, such as personnel on a carrier, must be rugged and simple to use. Their weight and volume should be kept as small as possible.

A preferred method of driving CPR apparatus for use in the field is by means of a compressed gas, in particular a compressed breathing gas like air or oxygen. The compressed gas drives a reciprocating apparatus provided with a piston in a cylinder. A compression pad is fixed at the free end of the plunger or piston rod, which extends from the cylinder. The compression pad is placed on the chest of the person under cardiac arrest. The reciprocating apparatus is held by a frame or support structure that comprises a back plate on which the patient rests in a recumbent position so as to be encircled by the back plate, the frame and the reciprocating apparatus. On the one hand, the frame must be strong and stiff enough to hold the apparatus at a constant distance above the patient's chest even during the administration of vigorous compressions provide with a force of several hundreds Newton. On the other hand the frame should be light-weight and easy to mount and dismount and to store. The driving gas for the apparatus is provided separately in a pressurized container, in particular a gas cylinder.

A support structure of this kind fulfilling the aforementioned requirements is known from US 2003/0181834; it is from this support structure that the present invention departs. The known support structure comprises a back plate and lateral legs mounted to a CPR apparatus at their one end and to the back plate at their other end.

### OBJECTS OF THE INVENTION

It is an object of the invention to provide a support frame for a CPR apparatus that is light-weight and easy to mount and dismount and to store while fulfilling the requirement of being strong and stiff enough to hold a reciprocating CPR apparatus at a constant distance above the patient's chest even during administration of vigorous compressions.

It is another object to provide a CPR apparatus provided with the frame.

Additional objects of the invention will become apparent from the study of the following summary of the invention, the description of a number of preferred embodiments thereof illustrated in a drawing, and the appended claims.

### SUMMARY OF THE INVENTION

According to the present invention is disclosed a support frame of the aforementioned kind comprising one or more inflatable elements. On inflation one or several chambers are formed in the inflatable element. If there are several chambers in the element they are in communication with each other. An inflatable element of the invention comprises a flexible but substantially not resilient wall. It is preferred for the wall to comprise one or more polymer materials or polymer layers. If the wall comprises more than one polymer material or layer it is preferred for them to form a multilayer structure in which adjacent layers are bonded to each other. The wall is preferably reinforced by fibres. Organic fibres such as carbon and/or polymer fibres of different composition than the polymer material of the wall can be used as well as fibres of vegetable origin such as cotton and cellulose acetate fibres. Useful inorganic reinforcing fibres include glass fibres, mineral fibres and metal fibres. Particularly suitable materials for manufacturing the inflatable elements of the invention include strong, close-weave mesh or net of polyester or nylon sandwiched between coatings of natural or synthetic rubber such as neoprene or polyurethane rubber or chlorosulfonated polyethylene (Hypalon®, DuPont), sheets of which cut to desired shape and size can be glued or thermobonded and additionally sewn to form an inflatable element. In this application any support element so designated is inflatable.

For its inflation the inflatable element of the invention has an opening in its wall at which gas conducting means is arranged, such as a flexible or stiff tube, which conducting means is in communication with a source of gas, preferably the same source of gas that provides the gas for driving the CPR apparatus, in particular a gas cylinder. The gas conducting means comprises or is coupled to a valve means for control of the inflation of the inflatable element. The valve means may be a one-way valve, in which case the inflatable element comprises a second wall opening at which a second valve for venting the gas in the element's chamber(s) or a conducting means in communication with a venting valve is mounted. The inflatable element of the invention should preferably withstand a pressure of at least 3 bar, more preferred at least 4 bar and even 5 bar. In general, the thickness of the flexible wall of the inflatable element is small in comparison with the diameter of the inflated element; a ratio of 1:25 or 1:30 and even up to 1:50 and more is preferred.

The CPR apparatus of the invention can be driven by a gas or by other driving means, such as electrical motor. If driven by a gas, it is preferred for the inflatable element to be arranged inflatable by the driving gas. According to a preferred aspect of the invention an inflatable element may serve as a reservoir or buffer of partially decompressed driving gas for a gas-driven CPR apparatus. The partially decompressed gas can be fed through the inflatable element to the CPR apparatus or the inflatable element can be connected by a T-junction to the gas line supplying the CPR with partially decompressed gas. A CPR apparatus of the aforementioned kind is preferably and usually driven by a compressed gas of constant or about constant pressure, the pressure being considerably lower than the pressure in the gas cylinder or other source of gas. The pressure in the gas cylinder or other source with a fixed amount of gas thus will decrease during operation of the CPR. Prior to being fed to the CPR apparatus the driving gas leaving the source is partially decompressed, that is, decompressed to the desired pressure for driving the apparatus. In contrast to the partial decompression of the gas leaving the gas cylinder to a given constant pressure gas consumption by the CPR apparatus varies considerably during a reciprocating cycle. To keep up with the varying consumption of driving gas by the CPR apparatus it is preferred to arrange a buffer volume or reservoir of partially decompressed gas, which function is advantageously carried out by the inflatable element of the invention. In such case partially decompressed gas in the inflatable element is, fed to the CPR apparatus.

According to a second preferred aspect of the invention the support frame comprises two inflatable legs and a back plate. The leg, which are preferably of about same size and form, extend from or are attached to opposite sides of the CPR apparatus, preferably in a mirroring manner. In this application the attached or extending ends are termed first ends. The other, second ends of the inflatable legs are releaseably mountable to and/or dismountable from the back plate. The back plate can be in one pieces or comprise two pieces of generally same shape, which can be easily attached to each other and dismounted.

According to a third preferred aspect of the invention the back plate comprises one or more inflatable elements, which may be inflatable separately from or in combination with the inflatable legs. It is preferred for the inflatable element(s) of the back plate to be integral with one or both legs; in such case it is preferred for the inflatable legs to be integral with and extend from opposite long sides of the inflatable back plate. It is preferred that this combination of inflatable legs and back plate is separate from the CPR apparatus to which it can be releaseably mounted by mounting means arranged at the free ends of the inflatable legs and at opposite sides of the CPR apparatus. It is also preferred for one or both of the mounting means to comprise means for establishing communication between the chambers of the inflatable elements of the frame and a source of partially decompressed driving gas via the CPR apparatus or separate from it. The material and design of the inflatable back plate of the invention allows to make it of a size capable of supporting the weight of an adult person, and thus suitable to be used as a stretcher, for which purpose outwardly facing portions of the back plate's long sides can be provided with handles.

A particular advantage of the inflatable frame and the inflatable or non-inflatable back plate of the invention is the small volume required for their storage and transport in a collapsed state. In contrast to stiff frames and back plates for CPR apparatus known in the art they can be folded or rolled up, and stored or transported in small containers.

According to a fourth preferred aspect of the invention the driving gas for driving the CPR is a breathing gas, which is adduced to the patient's lungs by a facial mask or intubation after having driven the CPR apparatus.

### SHORT DESCRIPTION OF THE DRAWINGS

The present invention will now be explained in more detail by reference to preferred but not limiting embodiments illustrated in a rough drawing, in which is shown in

FIG. 1 a first embodiment of the support frame of the invention, in a mounted state and a perspective lateral view;

FIG. 2a-2c a transverse section through the embodiment of FIG. 1, in a mounted state and with the patient's contour indicated;

FIG. 3 the embodiment of FIG. 1, in a dismounted state ready for storage, in the same view;

FIG. 4 a second embodiment of the support frame of the invention, in a mounted state and a perspective lateral view;

FIG. 5 the embodiment of FIG. 4, in a dismounted state ready for storage, in the same view;

FIG. 6 a block diagram illustrating the gas supply of the embodiment of FIGS. 4 and 5.

### DESCRIPTION OF PREFERRED EMBODIMENTS

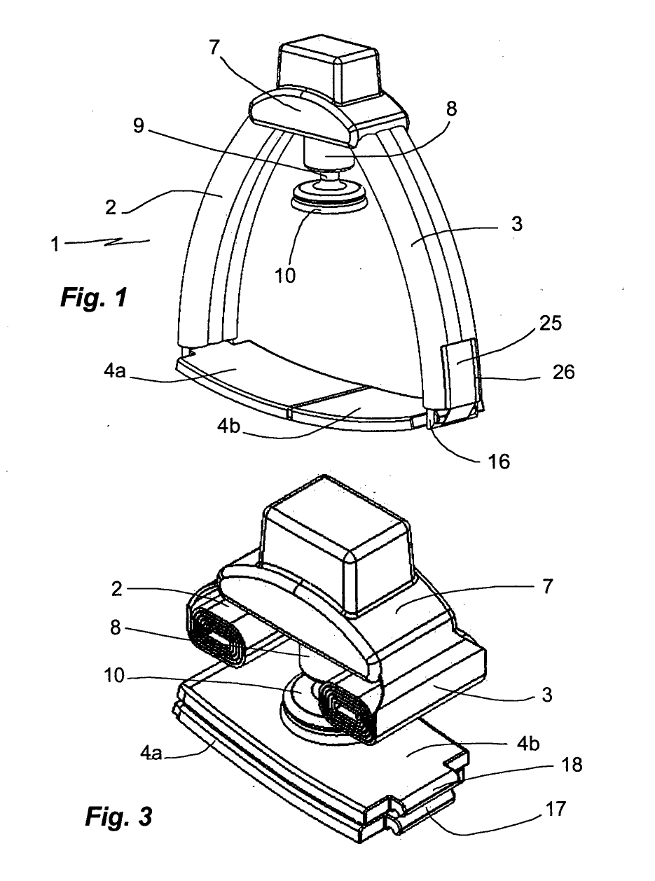

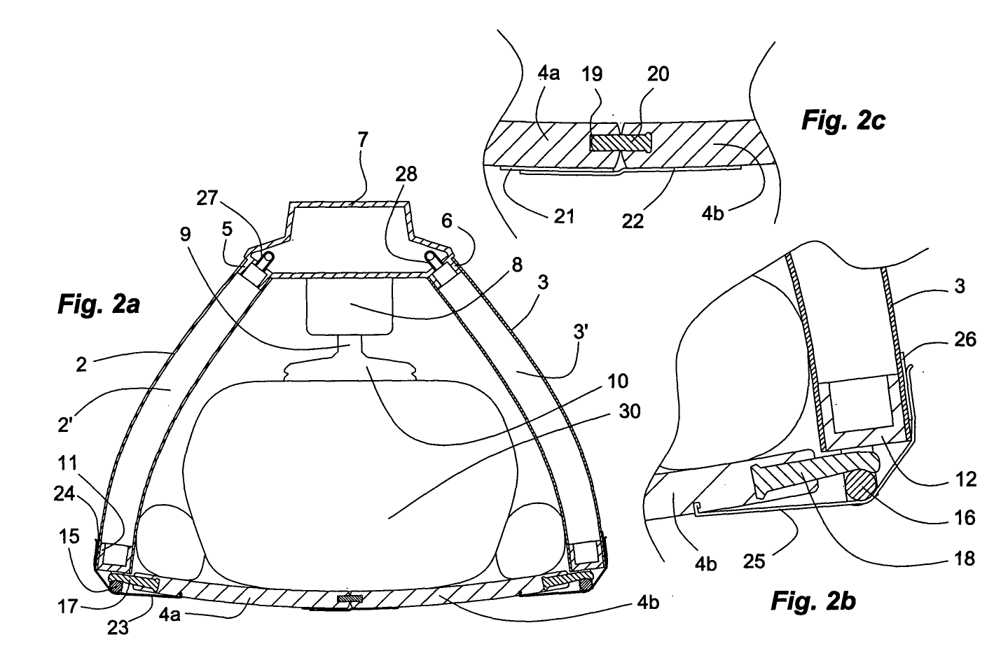

The first embodiment of a CPR support frame 1 of the invention illustrated in FIGS. 1 and 2a-2c in a mounted state and in FIG. 3 in a dismounted state comprises two inflatable legs 2, 3 and a stiff back plate comprising two sections 4a, 4b that can be easily connected and disconnected. The legs 2, 3 are of flexible but substantially not extendable polymer material such as polyurethane reinforced by a mesh of nylon or the like. At their one, upper end, the legs 2, 3 are plugged on and sealingly fixed by gluing to connecting sleeve portions 5, 6 integral with and protruding from opposite sides of a CPR apparatus housing. The housing 7 is made of a stiff light weight material such as a magnesium alloy but a non-conducting polymer material is preferred to eliminate the risk of aberrant electrical conduction during defibrillation. A preferred material for the housing is glass fibre-reinforced polyamide. The CPR apparatus comprises a gas driven reciprocating piston mounted in a cylinder 8 from which the piston rod or plunger 9 extends with a chest compression pad 10 attached at its lower end, which abuts the chest 30 of a patient above the sternum. The free ends of the legs 2, 3 are plugged on and sealingly fixed by gluing to plugged metallic bushings 11, 12. At their bottom the bushings 11, 12 carry eyes 15, 16. The back plate sections 4a, 4b of polyamide are of about rectangular shape and slightly curved in a longitudinal direction. They are connected along their short sides by a flange element 20 embedded in the back plate section 4b shown at right hand in FIG. 2a from which it protrudes and is inserted into a corresponding slit 19 arranged in the other back plate section 4a; since this, connection is affected by strong upwardly directed bending forces acting the free lateral edges of the back plate sections 4a, 4b via the legs 2, 3 during the compression phase it is important to make the connection sturdy, for instance by reinforcing the polymer material in the slit 19/flange 20 region. It is of course possible to use a back plate that is not segmented. The flange element 20 is held in the slit 19 by a Velcro®-type connection comprising two barbed straps 21, 22 attached to underside of back plate sections 4a and 4b, respectively, the one, shorter strap 21 being glued on the underside of back plate section 4a, whereas one end of the other, longer strap 22 is embedded in the other back plate section 4b. At their free ends the legs 2, 3 are attached to the combined back plate sections 4a, 4b. Metal hooks 17, 18 embedded in plate sections 4a and 4b, respectively, and protruding from the free short side of the combined section 4a, 4b are inserted into the eyes 15, 16 disposed at the free ends of the legs 2, 3. The hooks 17, 18 are held in place by pairs of Velcro® straps 23, 24 and 25, 26. One end of the straps 23, 25 is embedded in back plate section 4a, 4b, respectively, from which it protrudes. The other, shorter straps 24, 26 are glued on a terminal section of the face of the respective leg 2, 3 facing away from the slit 19/flange 20 connection. Each of the connecting sleeve portions 5, 6 is provided with a bore in its bottom, in which gas pipes 27, 28 are mounted. The gas pipes 27, 28, by which the voids 2′, 3′ of the legs 2, 3 are filled with compressed gas, are connected to a valve manifold (not shown) that controls the supply of compressed air from a gas cylinder to the CPR apparatus. In a dismounted state (FIG. 3) the flexible legs 2, 3 are rolled up or folded, and the sections 4a, 4b of the back plate are separated. The elements of the support frame 1 and the CPR apparatus can now be stored in a volume saving manner.

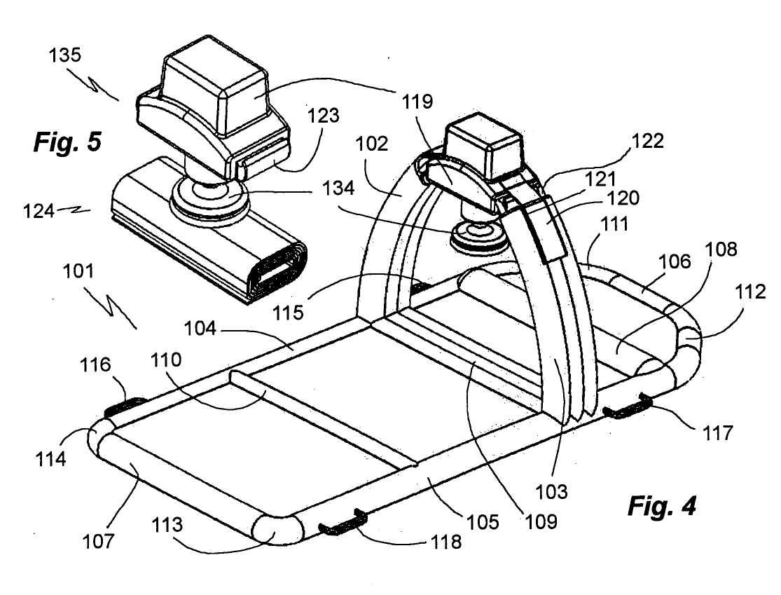

The second embodiment of a CPR support frame 101 of the invention illustrated in FIG. 4 in a mounted state comprises two inflatable legs 102, 103 joined to a base of inflatable elements 104, 105, 106, 107, 108, 109, 110, 111, 112, 113, 114, the lumina of which are in communication with each other and with the lumina of the legs 102, 103. The base 104-114 is a generally flat structure also in the inflated state shown in FIG. 4. The base comprises a rectangular framing 104, 105, 106, 107 with rounded corner portions 111, 112, 113, 114. Reference numbers 104, 105 designate opposite long-side inflatable elements whereas reference numbers 106 and 107 designate opposite short-side inflatable elements. The long-side elements 104, 105 are additionally connected by bridging elements 108, 109, 110. The bridging element 109 connects the long-side elements 104, 105 at their portions from which the inflatable legs 102, 103 rise about perpendicularly above the base 104-114. The base 104-114 is so dimensioned that an adult person of average size resting in a supine position on the base will, with the obligate position of his/her heart and sternum above the bridging element 109 and below the chest compression pad 134 of a CPR apparatus mounted at the upper ends of the legs 102, 103, have his or her neck positioned on bridging element 108 and the buttocks on bridging element 110. In an inflated state the base 104-114 is stable enough to be used as a stretcher. For this purpose pairs of handles 115, 116 and 117, 118 are fastened at portions of the elements 104 and 105 facing away from the bridging elements 108-110 and close to the head end and the foot end, respectively.

The free ends of the legs 102, 103 are provided with fastening means by which the legs can be fastened at opposite sides of a CPR housing 119 by any suitable releaseable fastening means, for instance means of the same kind as used for fastening the free ends of the legs 2, 3 of the first embodiment to the back plate sections 4a, 4b. One of the releaseable fastening means is identified in FIGS. 4 and 5 by reference numbers 123, hook on the right side (in a cranial direction) of the housing 119 inserted into eye 122 fixed at the outer face of the bottom of a plugged bushing on inserted into the upper end of leg 103, which is glued to it; Velcro® straps 121, 120, of which strap 121 is glued on an upper end portion of leg 103, strap 120 is fixed at the CPR housing 119 and attached with its free end portion to strap 121. In FIG. 5 the inflatable portion 124 of the CPR support frame 101 is shown in a rolled-up state for storage and transport in combination with the disconnected CPR unit 135.

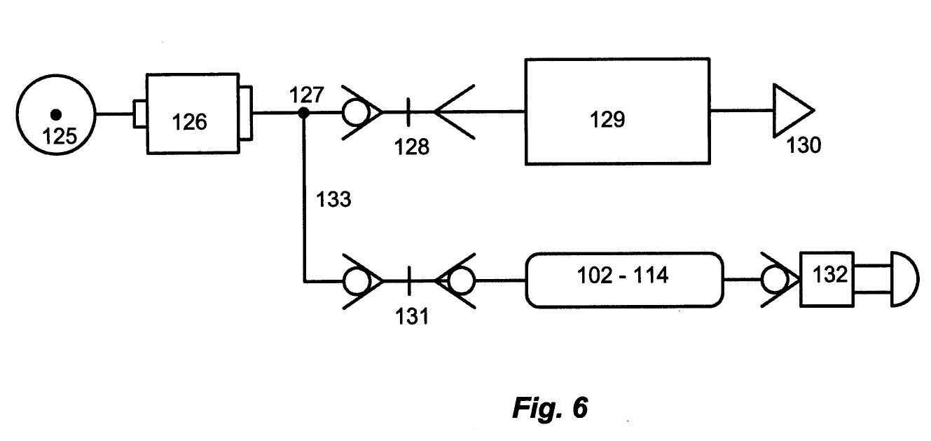

For inflation the lumen of the support frame 102-114 is put in communication with the source of driving gas by a high pressure hose 133 branching off from the gas supply line 127 connecting a differential pressure controller or regulator 126 fed by air from a gas cylinder 125 with the cylinder space 129 of the CPR unit 135 via a quick coupling 128 provided with a check valve (FIG. 6). Reference number 130 designates an air exhaust of the cylinder space 129; the exhaust 130 can be coupled to a breathing mask or an intubation set (not shown) to support the breathing of the patient. By means of a quick coupling 131 provided with check valves on either side the hose 133 is connected to the support frame 102-114, which can be deflated via a push button operated check valve 132.

1. A support frame for a CPR apparatus, in particular a gas-driven CPR apparatus, comprising one or more support elements inflatable by a gas, in particular the driving gas of the apparatus.

2. The support frame of claim 1, wherein an inflatable support element comprises, in an inflated state, one chamber or several communicating chambers.

3. The support frame of claim 1, wherein said one or more inflatable elements have a flexible but substantially not resilient wall.

4. The support frame of claim 3, wherein said wall comprises one or more polymer materials and/or polymer layers.

5. The support frame of claim 4, wherein the more than one polymer materials and/or layers are comprised by a multilayer structure in which adjacent layers are bonded to each other.

6. The support frame of claim 3, wherein the wall comprises a reinforcement selected from fibre, textile, and/or net of polymer material.

7. The support frame of claim 1, wherein an inflatable element is connected to a gas conducting means in communication with a gas source.

8. The support frame of claim 7, wherein the gas source is one of a breathing gas.

9. The support frame of claim 7, wherein the gas conducting means comprises a valve means for control of the inflation of the support element.

10. The support frame of claim 1, wherein the support element comprises a gas outlet including a venting valve.

11. The support frame of claim 1, comprising a base, a CPR apparatus housing, an inflatable first leg extending between one side of the housing and one side of the base and a second inflatable leg extending between the opposite side of the housing and the opposite side of the base.

12. The support frame of claim 11, wherein the legs have first open ends connected to gas conducting studs of the housing and second ends connected to the base.

13. The support frame of claim 11, wherein the second ends are closed.

14. The support frame of claim 11, wherein the connection of the legs with the base is releaseable.

15. The support frame of claim 11, wherein the base comprises a generally rigid back plate.

16. The support frame of claim 15, wherein the back plate consists of two disconnectable halves.

17. The support frame of claim 11, wherein the second ends of the legs are attached to opposite long sides of a base comprising one or more inflatable elements and which base is substantially longer than the distance between the second ends.

18. The support frame of claim 17, wherein at least one of the second ends is in fluid communication with the base.

19. The support frame of claim 17, wherein one or both second ends are integral with the base.

20. The support frame of claim 17, wherein the base in an inflated state is sufficiently rigid for use as a stretcher for carrying an adult person under cardiopulmonary resuscitation.

21. The support frame of claim 20, wherein the base is provided with handles disposed at its long sides.

22. The support frame of claim 1, wherein driving gas is a breathing gas.

23. The support frame of claim 22, wherein the used driving gas or a portion thereof is adduced to the patient's lungs by a facial mask or by intubation.

24. A gas-driven CPR apparatus comprising the support frame of claim 1.

25. A CPR apparatus mounted in a support frame comprising two inflatable legs fixed to or integral with a base from opposite sides of which they extend, their free ends being releaseably attached to opposite sides of the apparatus.

26. The apparatus of claim 25, wherein the base is rigid.

27. The apparatus of claim 25, wherein the base is inflatable.

28. The apparatus of claim 27, wherein the base and at least one of the legs are in fluid communication.

29. A CPR apparatus mounted in a support frame comprising two inflatable legs releaseably attached to opposite sides of a base with their first ends and fixed to opposite sides of the apparatus with their second ends.

30. The apparatus of claim 29, wherein the base is rigid.

31. The apparatus of claim 29, wherein the base is inflatable.
